(19) United States
(12) Patent Application Publication
(10) Pub. No.: US 2026/0039081 A1
(43) Pub. Date: Feb. 5, 2026

(54) SYNCHRONIZING LASER DITHER AND CORRELATOR CLOCKS TO IMPROVE DYNAMIC LIGHT SCATTERING

(71) Applicant: Dimer Instruments, Inc., Santa Barbara, CA (US)

(72) Inventors: Stephen C. Minne, Santa Barbara, CA (US); Michael I. Larkin, Santa Barbara, CA (US)

(21) Appl. No.: 18/794,234

(22) Filed: Aug. 5, 2024

(51) Int. Cl. H01S 3/00

(52) U.S. Cl. CPC H01S 3/0085; H01S 3/0057

(57) ABSTRACT

A method, system, and apparatus for synchronizing laser dither and correlator clocks to improve dynamic light scattering is disclosed. An example laser dither and correlator synchronizing system includes a laser driver configured to output a laser. The example laser dither and correlator synchronizing system further includes a correlator having an internal clock. The example laser dither and correlator synchronizing system further includes a waveform generator configured to receive a clock signal from the internal clock of the correlator, receive a dither signal from a controller, and output a laser modulation signal to the laser driver based on the dither signal and the clock signal.

### BACKGROUND

Using solid state lasers in analytical instruments is advantageous because of their small size, low cost, and high power. Unfortunately, it is well known that solid state lasers suffer from mode hopping, which can cause their intensity to vary uncontrollably. There have been many successful innovations that mitigate solid state laser mode hopping in applications ranging from optical disk recording systems to fiber optic communication to static light scattering. These solutions often involve oscillating the laser diode's intensity to force the laser through many modes to stabilize the laser and subsequently average the intensity signal, otherwise known as laser dither.

Dynamic light scattering (DLS) is an application where these mode hopping mitigations have been previously unsuccessful. Mitigating mode-hopping in DLS is particularly difficult because the DLS signal acquisition typically requires sampling in the 10 MHz-40 MHz range. For a dither (e.g., intentional oscillation to force a laser though modes) to not impact the measurement itself, the dither frequency must be many times higher than the acquisition frequency. However, for cost and complexity reasons it is difficult to dither a DLS laser much faster than 40 MHz. Alternatively, if a dither is only a little faster than the correlator, frequency artifacts will appear because different countable numbers of dither peaks are present in each integration period.

Therefore, there is a need for an approach to mitigate laser mode hopping during DLS measurements.

### SUMMARY

Disclosed herein are methods, systems and apparatus for synchronizing laser dither and correlator clocks to improve dynamic light scattering.

This application discloses an approach to mitigate laser mode hopping during DLS measurements by synchronizing the laser dither to the correlator's frequency, to enable an artifact free laser dither mitigation of mode hopping in a practical, cost-effective way. Throughout this disclosure, the term “correlator frequency” is synonymous with, and can be interchanged with, the term “the frequency associated with the correlator's minimum sampling time bin.”

Mode hopping in semiconductor lasers is a phenomenon where the laser output switches discontinuously between different longitudinal modes. This behavior is highly undesirable in many applications, such as fiber optic communications, optical storage, and scientific instruments, as it introduces significant intensity noise and instability in the laser output.

Typically, the wavelength of a laser diode shifts gradually, but at certain points, the wavelength can abruptly change, resulting in a mode hop. This sudden shift occurs when the laser transitions from one longitudinal mode to another. During mode hopping, the output intensity of the laser fluctuates, leading to increased relative intensity noise.

The main factors that contribute to mode hopping in semiconductor lasers include temperature fluctuations, injection current variations, optical feedback, and mechanical stability. Using design best-practices to mitigate the above root causes of mode hopping does not result in a laser diode output that is sufficiently stable for accurate DLS.

Laser dithering was developed to mitigate the effects of mode hopping. Notable advancements in this area have been reported in the context of fiber-optic communication systems, optical data storage, and static light scattering. A summary of the prior art, and a detailed description of the utility of laser dithering in static light scattering, can be found in U.S. Pat. No. 5,475,235.

U.S. Pat. No. 5,475,235 describes a technique where the laser drive current is modulated at a low frequency and low amplitude, but sufficient to induce mode hopping. This controlled mode hopping ensures that the laser operates through various modes. Because the modulation occurs outside of the measurement bandwidth, resultant signal along with its fluctuations are averaged, resulting in a very stable output power. The method disclosed in U.S. Pat. No. 5,475,235 also includes a feedback mechanism where the scattered light signal is ratioed against the incident laser power. This low frequency stabilization is a requirement that is specific to static light scattering measurement.

A laser diode driver system with modulation capabilities is the basic requirement for laser dithering. The laser diode driver typically functions as a constant current source, although many off the shelf and OEM commercial solutions incorporate a modulation input that enables dynamic adjustments of the laser diode output. The modulation input can accept external analog signals, including but not limited to sine, triangle, or square waves, thereby enabling precise modulation of the laser diode current or power, or laser dither. Throughout this application we will refer to laser dither, or dither frequency, and in all cases this signal can have the form of a sine wave, a triangle wave, any other arbitrary shape, or any shape approximating any aforementioned shape.

Key specifications of any modulating laser diode driver include modulation bandwidth and depth of modulation. The modulation bandwidth defines the range of frequencies over which the laser diode driver can effectively modulate the laser diode. The depth of modulation specifies the extent to which the modulation input signal is faithfully reproduced in the laser diode output without distortion.

It is well known how to modulate a laser in the MHz range. The write-optics in optical storage devices (DVD, CD, etc.) routinely use laser diodes operating in this range. For example, the Texas Instruments LMH6525 Four-Channel Laser Diode Driver with Dual Output is specified to operate between 200 MHz and 600 MHz, where the specific frequency is controlled with resistor selection as opposed to a modulation waveform.

While the methods of U.S. Pat. No. 5,465,235 and other similar approaches have demonstrated efficacy in their target domains, none address the specific challenges encountered in DLS applications. DLS is based on the analysis of the light scattered by particles undergoing Brownian motion in a fluid. When a laser light illuminates the sample, the particles scatter the light in different directions. The scattered light intensity fluctuates over time due to the random motion of the particles.

Because particles of interest for typical DLS measurements can be as small as sub-nanometer and as large as micrometers, the effects of the Brownian motion need to be characterized in the range from nanoseconds to seconds. This large range makes accurate DLS measurements particularly sensitive to laser intensity noise anywhere in that bandwidth. In other words, mode hopping during a DLS measurement can lead to significant measurement errors.

The measurement of scattered light intensity fluctuations in DLS applications is performed using a detector, typically a single photon counting module or a photo multiplier tube, placed at a specific angle to the incident laser beam. The detector signal, I(t), is then analyzed using a digital correlator, intended to create the best discrete approximation to the equation below (which is the raw data needed for DLS analysis):

$${g}_{2} ( τ ) = \frac{〈 I ( t ) \cdot I ( t - τ ) 〉}{{〈 I ( t ) 〉}^{2}}$$

where τ is time lag. The time lag, τ, can be linear or logarithmic in spacing, where the logarithmic (multi-tau) approach is most practical for DLS.

A multi tau correlator system employs a hierarchical clock management approach to efficiently process photon counting data. Central to its operation is the organization of data into sampling time blocks (STBs). Each subsequent block within this system operates at half the clock frequency of the preceding one, thereby effectively doubling the sampling time for each successive block. Initial blocks function at high frequencies, such as 40 MHz, with each subsequent block operating at progressively lower frequencies (e.g., 20 MHz, 10 MHz).

Additionally, the correlator system integrates an embedded processor tasked with managing larger STBs. This processor is responsible for fetching data and performing necessary calculations and it operates with computational clock frequencies that are appropriate for large calculations. This integration ensures continuous and precise real-time computation and normalization of correlation functions.

By effectively managing a wide range of timescales, the multi-tau system achieves the necessary statistical accuracy for scientific applications. In summary, 1) the multi-tau's correlator's clock is necessarily in the 10's of MHz range, and 2) its management within the correlator, and the FPGA, is essential for accurate dynamic light scattering measurements.

The purpose of the invention disclosed herein is to provide a practical and cost-effective intensity stabilized diode laser source and a multi-tau correlator in a way that does not produce artifact in the DLS autocorrelation function. This is a non-trivial exercise because the direct combination of prior art will result in DLS signals that are substandard either economically, or due to artifacts in the autocorrelation function.

A direct application of laser dither at a frequency much greater than the correlator frequency (e.g., 100×40 MHz or 4 GHz) would have the desired intensity stabilizing effect, but come at prohibitive design complexity and cost (specialized components, radiation suppression, etc.). In general, to simplify instrumentation design, it is preferred to operate at frequencies all well below 100 MHz.

While operating closer to the correlator frequency would address cost and complexity issues, it would have the undesirable effect of introducing artifact into the autocorrelation function. A novel solution is to match the dither frequency to the correlator frequency. In this case there will be an identical number of periods in each sample, and therefore, the sampled signal is constant and artifact free.

However, this solution of matching the dither frequency to the correlator frequency is only valid in the theoretical case. In a physical design, the correlator clock and the dither clock may both be nominally identical (e.g., 40 MHz) but in reality, the two separate clocks will not be perfectly matched. The best specifications that can be expected from a high-quality clock is 5-10 ppm accuracy, or in other words, two 40 MHz clocks could differ by as much as 800 Hz.

Analogous to the example given above, a 40 MHz dithered signal sampled at 40 MHz+400 Hz, will produce a beat frequency at the difference of the signals. In this example, the 400 Hz beat frequency will create a significant artifact at long correlation times. It should be noted that the long correlation times are particularly important in DLS as they represent the region of interest for large particles. The accurate measurement of large particles has many important applications in polymers, nanotechnology, some virus and lipid nanoparticles, and in applications where particles are used for DLS calculation of viscosity.

Both causes of artifacts can be mitigated by synchronizing the dither and correlator clocks by either using the correlator clock, or by creating an independent master clock. It is not obvious to do either of these solutions because these two components are independent and complex, and often sourced from different vendors or built from different disciplines. Likewise, neither of the components have default access to the relevant clock signals.

Aspects of the subject matter described herein may be useful alone or in combination with one or more other aspect described herein. Without limiting the foregoing description, in a first aspect of the present disclosure a laser modulation system comprises a laser driver configured to output a laser; a correlator having an internal clock; and a waveform generator configured to receive a clock signal from the internal clock of the correlator, receive a laser control signal from a controller, and output a laser modulation signal to the laser driver based on the laser control signal and the clock signal.

In accordance with a second aspect of the present disclosure, which may be used in combination with the first aspect, the waveform generator is configured to synchronize a clock frequency of the correlator with a dither frequency of the laser driver modulation signal.

In accordance with a third aspect of the present disclosure, which may be used in combination with any other aspect disclosed herein, the correlator is a multi-tau correlator.

In accordance with a fourth aspect of the present disclosure, which may be used in combination with any other aspect disclosed herein, the laser modulation system used in a dynamic light scattering (DLS) system.

In accordance with a fifth aspect of the present disclosure, which may be used in combination with any other aspect disclosed herein, the laser modulation signal further contains a laser amplitude signal to adjust an amplitude of the laser.

In accordance with a sixth aspect of the present disclosure, which may be used in combination with any other aspect disclosed herein, the waveform generator is configured to combine the laser amplitude signal and the laser modulation signal into a laser input signal.

In accordance with a seventh aspect of the present disclosure, which may be used in combination with any other aspect disclosed herein, the waveform generator includes the laser driver.

In accordance with an eighth aspect of the present disclosure, which may be used in combination with any other aspect disclosed herein, a shape of the laser modulation signal approximates a triangle wave.

In accordance with an ninth aspect of the present disclosure, which may be used in combination with any other aspect disclosed herein, a laser modulation system comprises a correlator having an internal clock; and a laser driver configured to output a laser, wherein a dither frequency of the laser driver is based on a clock signal received from the internal clock of the correlator.

In accordance with a tenth aspect of the present disclosure, which may be used in combination with any other aspect disclosed herein, a laser modulation system comprises a laser driver configured to output a laser; a clock output, wherein the clock output controls a dither frequency signal; a correlator, configured to receive a clock signal from the clock output; and a waveform generator configured to receive the dither frequency, and output a laser modulation signal to the laser driver based on the dither frequency signal.

In accordance with a eleventh aspect of the present disclosure, which may be used in combination with any other aspect disclosed herein, the clock output is contained in a controller.

In accordance with an twelfth aspect of the present disclosure, which may be used in combination with any other aspect disclosed herein, a method of modulating a laser comprises receiving a clock signal synchronized to a correlator clock; receiving a dither signal synchronized to the clock signal; outputting a laser modulation signal to a laser driver based on the dither signal; and outputting a laser based on the laser modulation signal, wherein the laser illuminates a sample for DLS analysis of the sample.

In accordance with a thirteenth aspect of the present disclosure, which may be used in combination with any other aspect disclosed herein, the clock signal is from an internal clock of a correlator.

In accordance with a fourteenth aspect of the present disclosure, which may be used in combination with any other aspect disclosed herein, the clock signal is generated from a clock external to a correlator.

In accordance with a fifteenth aspect of the present disclosure, which may be used in combination with any other aspect disclosed herein, a method of modulating a laser further includes adjusting a frequency of the clock external to the correlator to minimize the effects of a single photon counting module (SPCM) after pulsing in an output signal of the correlator.

In accordance with an sixteenth aspect of the present disclosure, any of the structure and functionality illustrated and described in connection with FIGS. 1 to 8 may be used in combination with any of the structure and functionality illustrated and described in connection with any of the other of FIGS. 1 to 8 and with any one or more of the preceding aspects.

In light of the present disclosure and the above aspects, it is therefore an advantage of the present disclosure to synchronize laser dither to an autocorrelator's frequency to enable artifact-free laser dither mitigation of mode hopping.

It is another advantage of the present disclosure to enable artifact-free laser dither mitigation of mode hopping in a practical, cost-effective way.

It is a further advantage of the present disclosure to enable artifact-free laser dither mitigation of mode hopping for high frequency sampling applications such as DLS.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram illustrating the origin of artifact by showing the effect of a 50 MHz dither being sampled by a 40 MHz correlator.

FIG. 2 is a diagram illustrating that the amplitude of a correlator output is zero when the dither and correlator frequencies are identical.

FIG. 3 is a schematic diagram of a known DLS apparatus.

FIG. 4 is a schematic diagram of a DLS apparatus equipped with a multi-tau correlator synchronized to a laser dither for practical artifact free low noise measurement, according to an example embodiment of the present disclosure.

FIG. 5 is a schematic diagram of a second DLS apparatus equipped with a multi-tau correlator synchronized to a laser dither for practical artifact free low noise measurement, according to an example embodiment of the present disclosure.

FIG. 6 is a schematic diagram of a third DLS apparatus equipped with a multi-tau correlator synchronized to a laser dither for practical artifact free low noise measurement, according to an example embodiment of the present disclosure.

FIG. 7 is a schematic diagram of a fourth DLS apparatus equipped with a multi-tau correlator synchronized to a laser dither for practical artifact free low noise measurement, according to an example embodiment of the present disclosure.

FIG. 8 is a flow diagram illustrating an example procedure for modulating a laser, according to an example embodiment of the present disclosure.

### DETAILED DESCRIPTION

The present disclosure relates in general to a method, system, and apparatus for mitigating laser mode hopping for high acquisition frequency applications such as dynamic light scattering (DLS). As disclosed herein, the method comprises synchronizing laser dither to an autocorrelator's frequency to enable artifact-free laser dither mitigation of mode hopping.

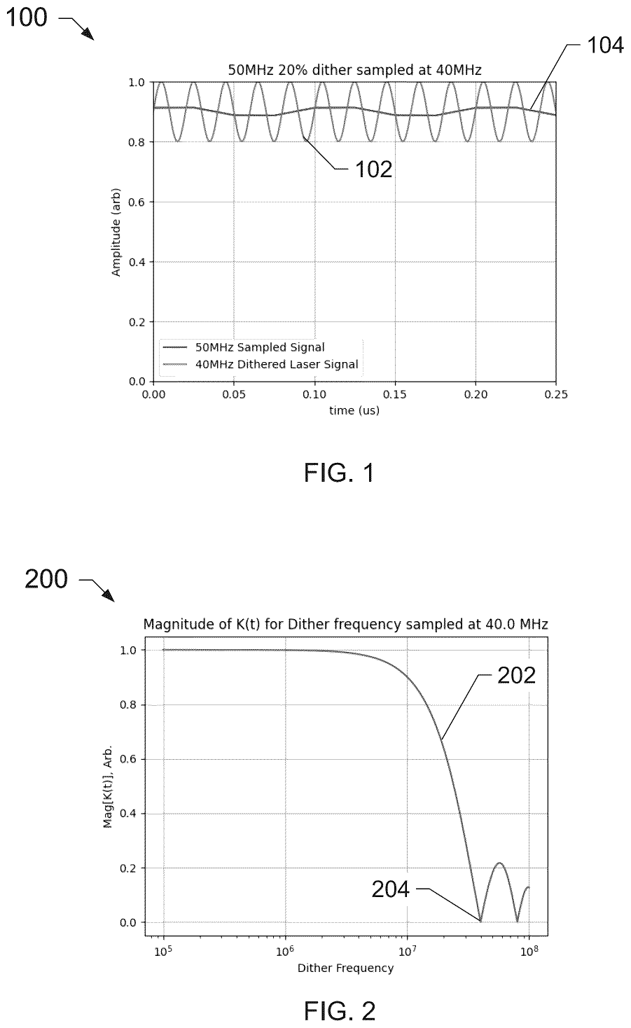

FIG. 1 is a diagram 100 illustrating the origin of artifact in an autocorrelator function when a laser dither frequency is close to the correlator frequency. As discussed above, applying laser dither at a frequency much greater than the correlator frequency (e.g., at a frequency of 100×40 MHz or 4 GHz) would have the desired stabilizing effect, but would be prohibitively complex and costly. While operating the laser dither at a frequency closer to the correlator frequency would address cost and complexity issues, it would have the undesirable effect of introducing artifact into the autocorrelation function. As seen in the diagram 100 of FIG. 1, a first time trace 102 shows a 50 MHz dithered laser signal and a second time trace 104 shows the dithered laser signal being sampled by a 40 MHz correlator. Ideally, the dither should not show up in the sampled signal, and the sampled signal (e.g., the second time trace 104) would have a constant amplitude. However, if there are a different countable number of periods in each of the correlator's time bins, an artifact will present itself in the autocorrelation function, as seen in the second time trace 104 of FIG. 1.

The preferred embodiment disclosed herein addresses artifacts created when a correlator averages a signal that contains a sinusoidal signal (in this case from the laser dither). The laser dither intensity I(t) may be represented by Equation 1 below where f represents the frequency of the sinusoidal signal and a represents the amplitude.

$$I ( t ) = a sin ( ω t ) , with ω = 2 π f , and T = 1 / f \qquad ( Equation 1 )$$

In the case the laser dither intensity I(t) is represented by Equation 1, a correlator averaging at a frequency of fₛ (or bin sizes of Tₛ=1/fₛ) will produce an output K(t) represented by Equation 2 below.

$${K ( t = n {T}_{s} - \frac{1}{2} {T}_{s} ) = \frac{1}{{T}_{s}} {\int }_{( n - 1 ) {T}_{s}}^{n {T}_{s}} I ( t ) dt = - \frac{a}{{T}_{s} ω} cos ( ω t ) \vert}_{( n - 1 ) {T}_{s}}^{n {T}_{s}} \qquad ( Equation 2 )$$

Equation 2 may be simplified to Equation 3 below where c is defined by Equation 4 below.

$$K ( t ) = - \frac{a c}{2 π} \frac{T}{{T}_{s}} cos ( 2 π n \frac{{T}_{s}}{T} + φ ) = - \frac{a c}{2 π} \frac{{f}_{s}}{f} cos ( 2 π n \frac{f}{{f}_{s}} + φ ) \qquad ( Equation 3 )$$

$$c = \sqrt{2 ( 1 - cos ( \frac{2 π {T}_{s}}{T} ) )} = \sqrt{2 ( 1 - cos ( \frac{2 π f}{{f}_{s}} ) )} \qquad ( Equation 4 )$$

If φ of Equation 3 is ignored, c is defined as shown in Equation 4, and by defining delta (δ) as the difference in frequency of the laser dither (f) and the correlator frequency (fₛ), or δ=f−fₛ, K(t) of Equation 3 simplifies to Equation 5 below.

$$K ( t ) = - \frac{a c}{2 π} ( \frac{{f}_{s}}{{f}_{s} + δ} ) cos ( 2 πδ t ) \qquad ( Equation 5 )$$

Examining Equation 5, the origin of the artifact is readily apparent. If delta (δ) is not zero, any difference between the correlator frequency and dither frequency will show up as a “beat” signal in the autocorrelation function at a frequency of delta (δ). This is most apparent from the frequency of the cosine term in Equation 5, which is simply delta (δ). Thus, when delta (δ) is exactly zero, there is no oscillation. Any increase in delta (δ) increases the artifact frequency in proportion.

FIG. 2 is a diagram 200 illustrating that the amplitude of correlator output K(t) is zero when the dither and correlator frequencies are identical, (i.e., delta (δ) equals zero). Graph line 202 shows a normalized magnitude of the amplitude of correlator output K(t), with a correlator sampling frequency of 40 MHz, as a function of dither frequency. The diagram 200 of FIG. 2 shows that it is also the case that the magnitude of the amplitude of K(t) is zero when delta (δ) is zero. For example, in the diagram 200, when the dither and correlator frequencies are identical (i.e., at point 204 at a dither frequency of 40 MHz) the magnitude of the artifact is zero.

As seen in Equation 5, even if delta (δ) is in the 100's of Hz, as one might expect from two nominally identical MHz clocks, a small but meaningful artifact will be created in important parts of the DLS signal. As expected, it is not until delta δ>>correlator frequency fₛthat the magnitude of the beat signal is eliminated.

Examples disclosed herein provide a way to ensure delta (δ) is zero while implementing laser dithering to suppress noise.

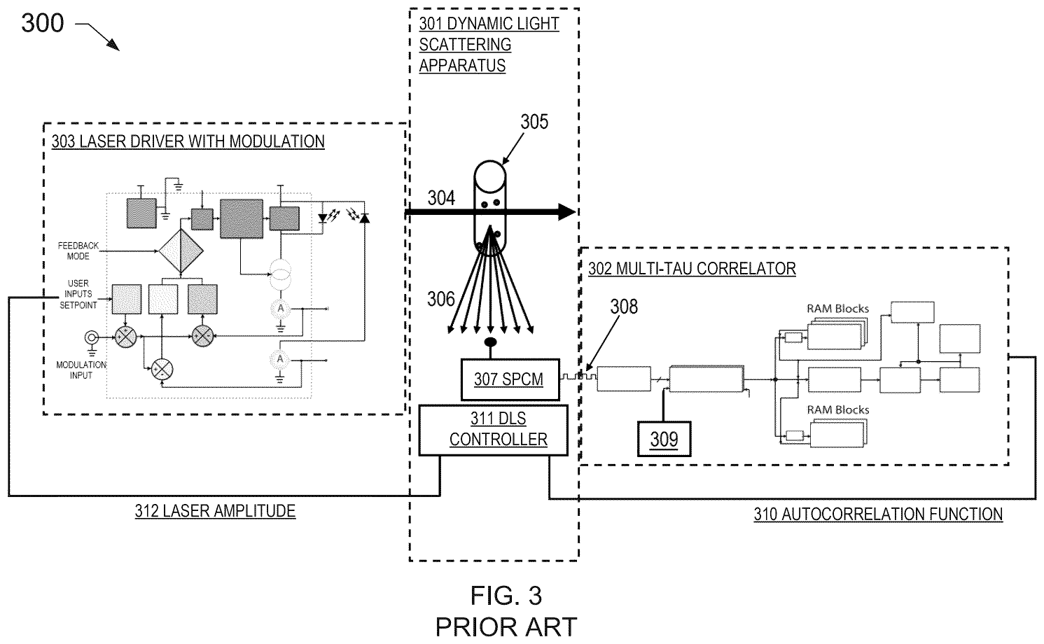

FIG. 3 shows a schematic of a standard or known dynamic light scattering (DLS) system 300. The known DLS system 300 includes a DLS apparatus 301, a multi-tau correlator 302, and a modulating laser driver 303. The known DLS system 300 operates when laser illumination 304 traverses a sample 305 and resultant scattered light 306 is collected by a detector. In the case of the known DLS system 300, the detector is a single photon counting module (SPCM) 307. The SPCM 307 generates a signal 308 which is fed into the multi-tau correlator 302. The multi-tau correlator 302 may be acquired as an off-the-shelf component or may be built following instructions in an extensive published scientific literature.

The example multi-tau correlator 302 as well as most known multi-tau correlators have an internal clock 309 that controls the SPCM sampling bin timing, the subsequent logarithmically spaced bins, and the embedded processing units. The multi-tau correlator 302 outputs the signal's autocorrelation function 310 which is fed back into a DLS controller 311 of the DLS apparatus 301 for processing into the final DLS result.

The DLS controller 311 is responsible for adjusting a laser amplitude such that the scattered light 306 does not overwhelm the SPCM 307 and/or the multi-tau correlator 302. For example, the DLS controller 311 outputs a laser amplitude signal 312 to the laser driver 303 to modulate an amplitude of the laser illumination 304. As previously discussed, even implementing laser diode design best practices, the technology of known DLS systems 300 is highly susceptible to laser mode hopping artifacts.

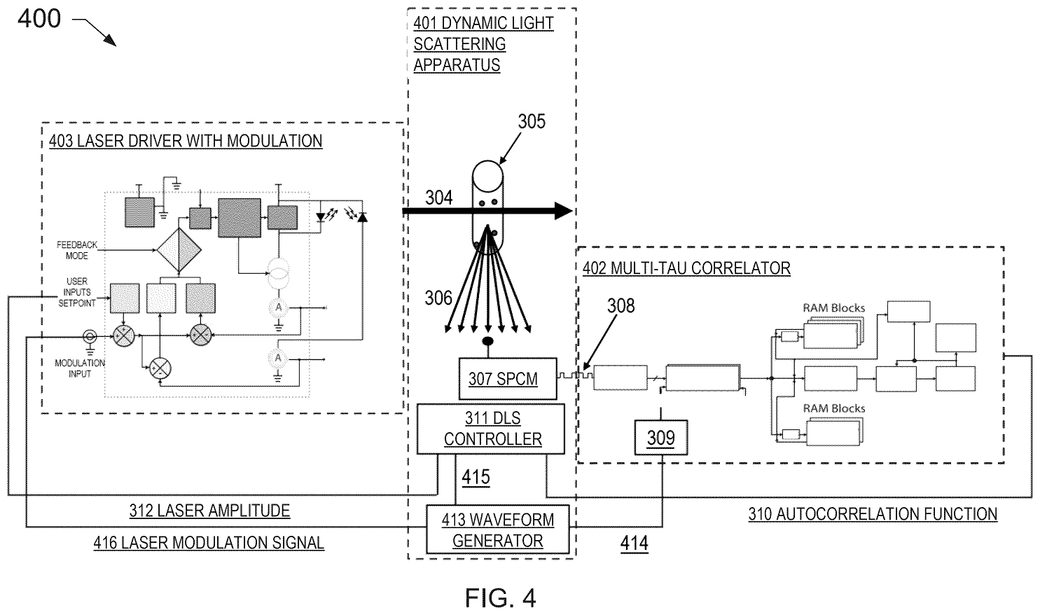

FIG. 4 shows a schematic of a DLS system 400, according to an example embodiment of the present disclosure. The DLS system 400 is improved compared to known DLS systems (e.g., the known DLS system 300 of FIG. 3) by implementing laser dither in a way that is both cost effective and not detrimental to performance. In the example DLS system 400, a standard DLS system (e.g., the known DLS system 300) is modified with a waveform generator 413. For example, the example DLS system 400 includes a multi-tau correlator 402 and a modulating laser driver 403 which may be substantially similar to the multi-tau correlator 302 and the modulating laser driver 303 of the known DLS system 300 of FIG. 3. However, the example DLS system 400 includes a DLS apparatus 401 including the waveform generator 413. The example waveform generator 413 can accommodate an external clock signal 414 and a laser control signal 415 (e.g., a dither signal) to generate a laser modulation signal 416 (e.g., laser driver input). The example laser modulation signal 416 may be a signal that includes one or more of laser dither frequency and modulation.

The result of the addition of the waveform generator 413 that is clocked off the clock 309 of the multi-tau correlator 402, is that delta (δ) in Equation 5 above necessarily becomes zero. Thus, the laser 304 can now be dithered in a way that will not produce an artifact in the autocorrelation function 310. It should be noted that there is no requirement to coordinate the phases of the clocks to gain this benefit.

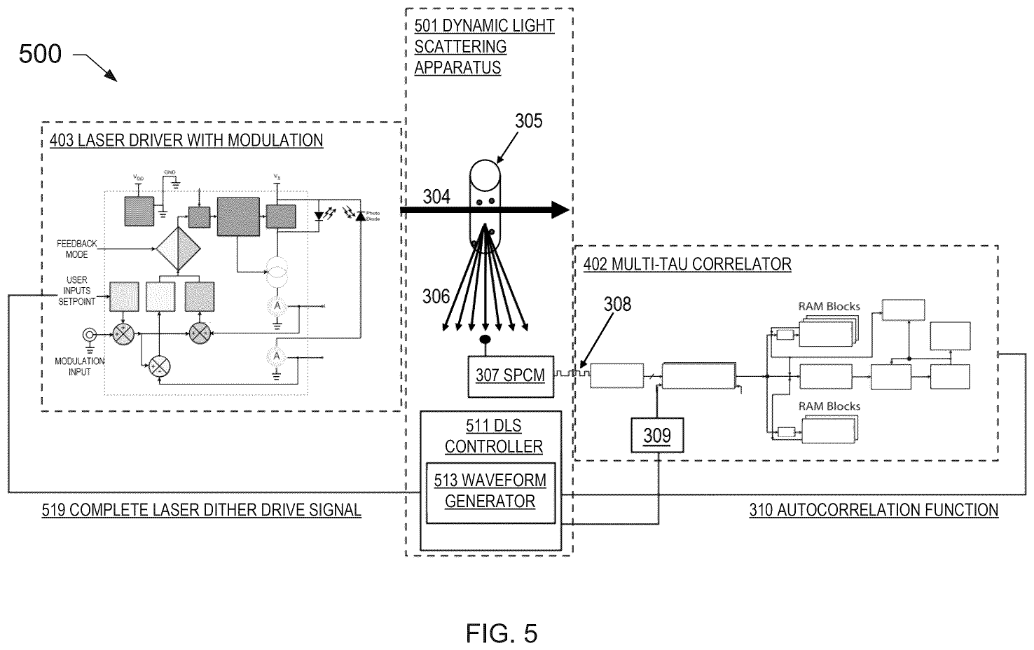

While the example of FIG. 4 shows an example embodiment of the present disclosure, it should be noted that there are many other embodiments which could be implemented to achieve the same result. For example, FIG. 5 shows a schematic of a second DLS system 500, according to an example embodiment of the present disclosure. In FIG. 5, the laser modulation signal 416 and the laser amplitude signal 312 of FIG. 4 have been be combined into a single signal (e.g., the complete laser dither drive signal 519). In another permutation shown in FIG. 5, the second DLS system 500 includes DLS apparatus 501 having a DLS controller 511. In the example of FIG. 5, the DLS controller 511 includes a waveform generator 513.

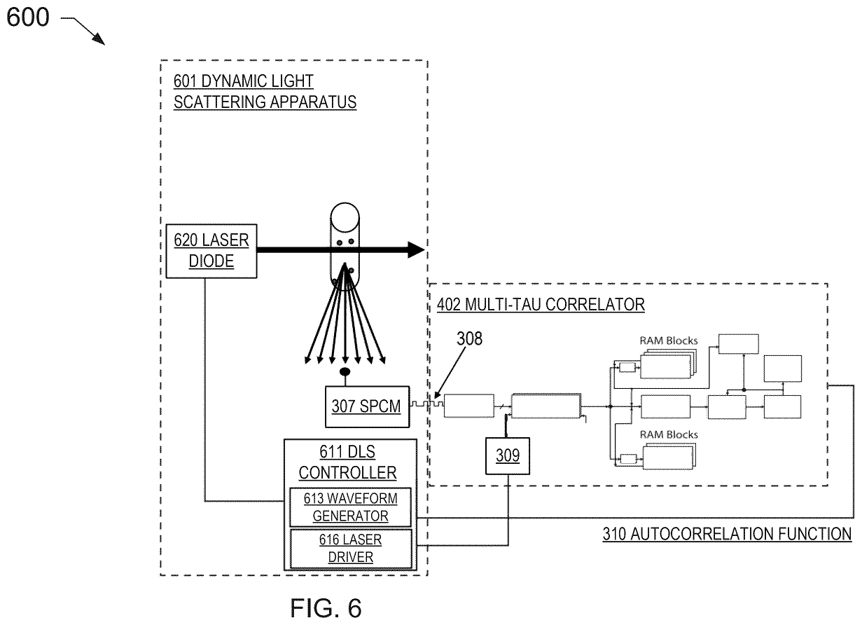

FIG. 6 shows a schematic diagram of a third DLS apparatus 600 having additional consolidation. The third DLS system 600 includes DLS apparatus 601 having a DLS controller 611 including both a waveform generator 613 and a laser driver 616. Additionally or alternatively, laser driver electronics could be implemented in the waveform generator 413. In another example, not shown, laser modulation could be directly driven with the clock signal 414. Additionally, the laser modulation disclosed herein may be implemented through a number of other electronic configurations which would be clear to those skilled in the art.

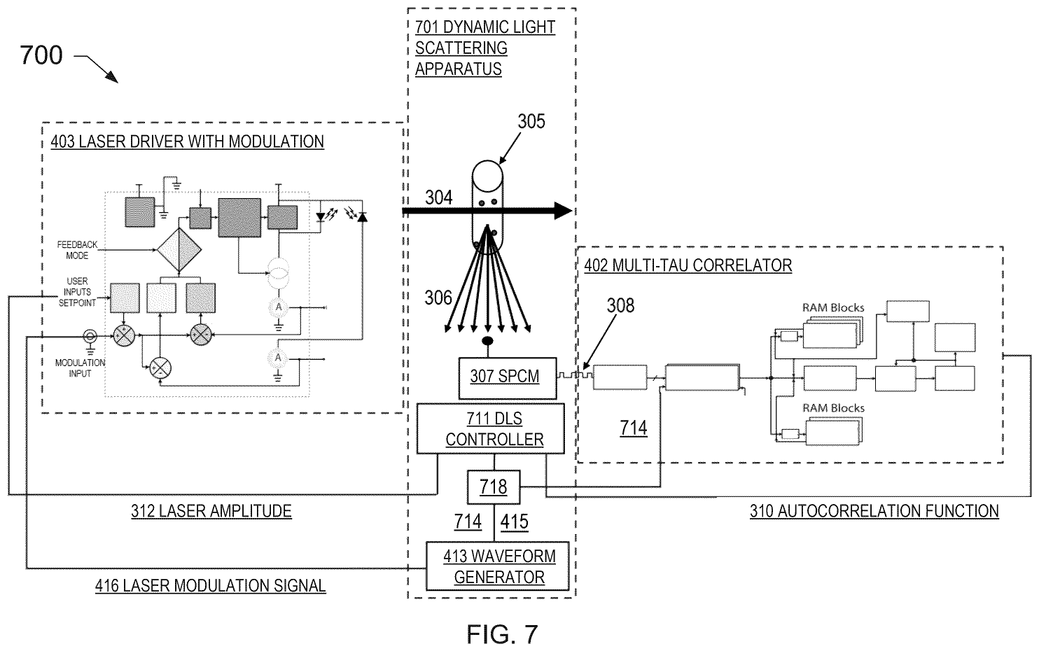

It should also be noted that there are other clock configurations that could be implemented by those skilled in the art. For example, FIG. 7 shows a schematic diagram of a fourth DLS apparatus 700, according to an example embodiment of the present disclosure. In the fourth DLS system 700, a DLS apparatus 701 includes a DLS controller 711 which generates a clock output 718. In some examples, the clock output 718 is contained within the DLS controller 711. The example clock output 718 may be used for controlling both the laser control signal 415 and the multi-tau correlator 402 through a dedicated clock input 714. It should be noted that a correlator clock input would need to be designed or otherwise accessible in this embodiment. The configuration of the fourth DLS system 700 has additional complexity compared to the DLS system as the correlator clock may be best managed by the correlator. However, having an external clock (e.g., the clock output 718) can provide the DLS apparatus 701 additional flexibility for controlling the overall system clock speed. For example, this flexibility could be useful for mitigating the effects of after pulsing in the SPCM 307. Such after pulsing could appear as an artifact in the output of the autocorrelation function 310. Another use for controlling the overall system clock would be adjusting the correlator's frequency to enable either higher resolution in, or a longer maximum time in, the autocorrelation function. There are a number of other electronic configurations for creating a clock that would be clear to those skilled in the art.

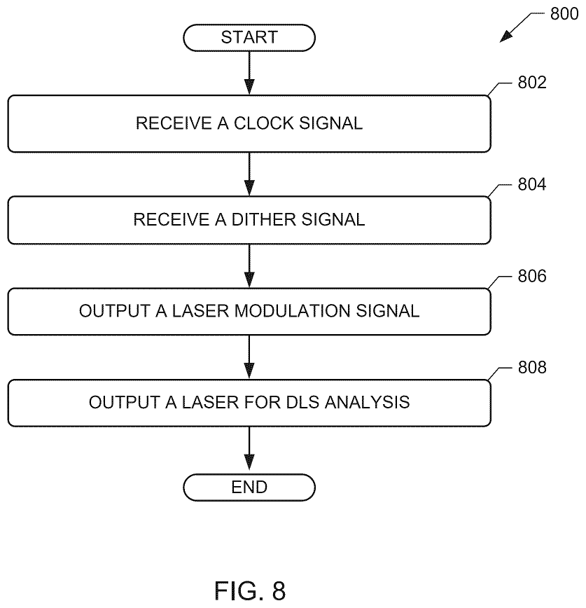

FIG. 8 is a flow diagram illustrating an example procedure 800 for modulating a laser, according to an example embodiment of the present disclosure. Although the procedure 800 is described with reference to the flow diagram illustrated in FIG. 8, it should be appreciated that many other methods of performing the functions associated with the procedure 800 may be used. For example, the order of the blocks may be changed, certain blocks may be combined with other blocks, and many of the blocks described are optional.

The example procedure 800 begins at block 802 when a clock signal synchronized to a correlator signal is received. For example, a waveform generator (e.g., the waveform generator 413 of FIG. 4) may receive a clock signal (e.g., the clock signal 414) from an internal clock of a correlator (e.g., the internal clock 309 of the multi-tau correlator 402 of FIG. 4). In other examples, the waveform generator may receive a clock signal from a clock (e.g., the clock 518 of FIG. 5) generated by a controller (e.g., the DLS controller 511 of FIG. 5). In these examples, the procedure 800 may further include a correlator receiving the clock signal from the external clock. In another example, a laser driver (e.g., the laser driver 403 of FIG. 4) may receive the clock signal.

At block 804, a dither signal is received. For example, a waveform generator (e.g., the waveform generator 413 of FIG. 4) may receive a dither signal (e.g., the laser control signal 415) from a controller (e.g., the DLS controller 311). In another example, the waveform generator may receive the dither signal from a clock (e.g., the clock 518) generated by the controller. In some examples, the dither signal may be synchronized to the clock signal when the dither signal is received. In other examples, the dither signal may be synchronized with the clock signal after it is received. At block 806, a laser modulation signal is output to a laser driver based on the dither signal. For example, a waveform generator (e.g., the waveform generator 413 of FIG. 4) may generate a laser modulation signal (e.g., the laser driver input 416) based on the clock signal 414 and the laser control signal 415 and output the laser modulation signal to a laser driver (e.g., the laser driver 403).

At block 808, For example, a laser driver (e.g., the laser driver 403 of FIG. 4) may output a laser (e.g., the laser illumination 304) for DLS analysis. As a result of the procedure 800 of FIG. 8, a dither frequency of the laser driver may be synchronized with a clock frequency of the correlator. In some examples, the clock frequency of the correlator may be an internal clock frequency while in other examples, the clock frequency of the correlator may be obtained from an external clock output by the controller.

### CONCLUSION

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

It should be appreciated that 35 U.S.C. 112(f) or pre-AIA 35 U.S.C 112, paragraph 6 is not intended to be invoked unless the terms “means” or “step” are explicitly recited in the claims. Accordingly, the claims are not meant to be limited to the corresponding structure, material, or actions described in the specification or equivalents thereof.

The invention is claimed as follows:

1. A laser modulation system comprising:
a laser driver configured to output a laser;
a correlator having an internal clock; and
a waveform generator configured to:
receive a clock signal from the internal clock of the correlator,
receive a laser control signal from a controller, and
output a laser modulation signal to the laser driver based on the laser control signal and the clock signal.

2. The laser modulation system of claim 1, wherein the waveform generator is configured to synchronize a clock frequency of the correlator with a dither frequency of the laser modulation signal.

3. The laser modulation system of claim 1, wherein the correlator is a multi-tau correlator.

4. The laser modulation system of claim 1, wherein the laser modulation system is used in a dynamic light scattering (DLS) system.

5. The laser modulation system of claim 1, wherein the laser modulation signal further contains a laser amplitude signal to adjust an amplitude of the laser.

6. The laser modulation system of claim 5, the waveform generator is configured to combine the laser amplitude signal and the laser modulation signal into a laser input signal.

7. The laser modulation system of claim 1, wherein the waveform generator includes the laser driver.

8. The laser modulation system of claim 1, wherein a shape of the laser modulation signal approximates a triangle wave.

9. A laser modulation system comprising:
a correlator having an internal clock; and
a laser driver configured to output a laser, wherein a dither frequency of the laser driver is based on a clock signal received from the internal clock of the correlator.

10. A laser modulation system comprising:
a laser driver configured to output a laser;
a clock output, wherein the clock output controls a dither frequency signal;
a correlator, configured to receive a clock signal from the clock output; and
a waveform generator configured to:
receive the dither frequency signal, and
output a laser modulation signal to the laser driver based on the dither frequency signal.

11. The laser modulation system of claim 10, wherein the clock output is contained in a controller.

12. A method of modulating a laser, the method comprising:
receiving a clock signal synchronized to a correlator clock;
receiving a dither signal synchronized to the clock signal;
outputting a laser modulation signal to a laser driver based on the dither signal; and
outputting a laser based on the laser modulation signal, wherein the laser illuminates a sample for DLS analysis of the sample.

13. The method of claim 12, wherein the clock signal is from an internal clock of a correlator.

14. The method of claim 12. wherein the clock signal is generated from a clock external to a correlator.

15. The method of claim 14. further including adjusting a frequency of the clock external to the correlator to minimize the effects of a single photon counting module (SPCM) after pulsing in an output signal of the correlator.
